(19) United States
(12) Patent Application Publication
(10) Pub. No.: US 2010/0040153 A1
(43) Pub. Date: Feb. 18, 2010

(54) DECODING APPARATUS AND DECODING METHOD

(75) Inventors: Takaaki Imanaka, Osaka (JP); Takeshi Tanaka, Osaka (JP); Hiroshi Ikeda, Osaka (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/513,743

(22) PCT Filed: May 1, 2008
(86) PCT No.: PCT/JP2008/001133

§ 371 Date: May 6, 2009

(30) Foreign Application Priority Data
May 7, 2007 (JP) 2007-122063

(51) Int. Cl. H04N 7/26

(52) U.S. Cl. 375/240.27; 375/240.24; 382/251; 375/E07.026; 375/E07.189; 375/E07.19; 382/254

(57) ABSTRACT

A decoding apparatus is provided which can perform error concealment accurately by reducing false detection of an error and detecting an error efficiently. The decoding apparatus (100) which decodes a coded image coded on a per-block basis, includes: a variable length decoding unit (101) that decodes a coded image; an error occurrence position detection unit (109) that determines a candidate block on which an error has possibly occurred, by using a quantization parameter which is obtained for each block and which is resulting from the decoding by the variable length decoding unit (101); and an error correction unit (110) that corrects blocks including and following the candidate block determined by the error occurrence position detection unit (109).

### TECHNICAL FIELD

The present invention relates to a decoding apparatus that performs error concealment (error correction), and in particular, to a decoding apparatus that accurately determines, after decoding is disabled, a position at which an error has occurred and corrects data from the determined error position.

### BACKGROUND ART

Conventionally, there is the Moving Picture Expert Group (MPEG) coding technique as a compression coding technique (hereinafter simply referred to as “coding”) using an inter-frame difference (see, Non-patent Reference 1).

Further, when decoding is disabled for some reason during decoding a coded image coded by using the MPEG coding technique, decoding is generally enabled by correcting data in which an error has occurred (hereinafter also referred to as error concealment).

One example of the error concealment techniques for a coded bitstream compliant with the MPEG 2 standard, after decoding is actually disabled, detects a macroblock on which an error has occurred and starts correction from the detected macroblock. In this case, it is empirically known as a method of detecting the macroblock on which an error has occurred (error occurrence position) to detect a macroblock several blocks before the macroblock on which decoding is actually disabled.

In recent years, the H.264 standard that embodies compression higher than the MPEG 2 standard has been presented, and is being widely in practical use. When the error concealment technique according to the aforementioned MPEG 2 standard is applied to an error concealment technique for a coded bitstream compliant with the H.264 standard, error concealment cannot be efficiently performed.

This is because, whereas it is empirically known, for a coded bitstream compliant with the MPEG 2 standard, that an error occurrence position can be determined as a macroblock several blocks before the macroblock on which decoding is disabled, it is difficult to detect, for a coded bitstream compliant with the H.264 standard, the macroblock on which an error has occurred. The reason for the difficulty in detecting an error occurrence position includes that the number of macroblocks from an error occurrence position through decoding failing position is great because the smaller number of bits than that of the MPEG 2 standard carries information in a variable length coding table in order to increase a compression efficiency.

A variety of methods for detecting an error position have been presented, and, among them, there is a technique of detecting an error position by using an image property (see Patent Reference 1).

The Patent Reference 1 discloses a technique for detecting an error by using an orthogonal transformation coefficient after detecting a decoding failure state of coded data in a coded bitstream.

FIG. 1 is a diagram for explaining a problem in the conventional error concealment technique. In the example as shown in the diagram, decoding is performed sequentially on macroblocks in a lateral direction, starting from the top-left macroblock of coded image 10.

As shown in FIG. 1, it is in many cases possible to continue decoding until decoding is actually disabled even after an error has occurred, according to the H.264 standard, however, images on and after the position on which the error has occurred are significantly distorted. The technique disclosed by the Patent Reference 1 utilizes that the orthogonal transformation coefficients differs greatly between the macroblock on which an error has occurred and a normal macroblock. For example, in the case where a difference value between DC components of the orthogonal transformation coefficients of adjacent macroblocks exceeds a predetermined threshold value, one of the adjacent macroblocks is determined as the macroblock on which an error has occurred. A corrected decoded image 11 can be obtained by performing error concealment on the determined macroblock and remaining macroblocks.

As described above, it is possible to output a corrected image by performing error concealment starting from, not the macroblock on which decoding is disabled, but the macroblock determined as a macroblock on which an error has actually occurred, according to the technique disclosed by the Patent Reference 1.
Patent Reference 1: Japanese Unexamined Patent Application Publication No. 2005-295054
Non-Patent Reference 1: ITU-T Recommendation H.262 “Information technology—Generic coding of moving pictures and associated audio information: Video”

### DISCLOSURE OF INVENTION

### Problems that Invention is to Solve

However, with the technique of detecting an error by using orthogonal transformation coefficients as disclosed by the Patent Reference 1, there is a problem of false detection of an error. More specifically, since the orthogonal transformation coefficients are coefficients that sharply indicate an image property, the orthogonal transformation coefficients significantly differ between macroblocks depending on a targeted coded image, and an error may be detected on even a macroblock on which an error has not occurred. In other words, there is a possibility that not only the macroblock on which an error has occurred, but also a macroblock having nothing to do with an error may be detected as a macroblock on which an error has occurred. This causes error concealment to be performed even on a properly decoded macroblock.

FIG. 2 is a diagram for explaining a problem in the conventional error concealment techniques. In the example as shown in FIG. 2, decoding is performed sequentially on macroblocks in a lateral direction, starting from the top-left macroblock of the picture, in the same manner as in FIG. 1.

As shown in FIG. 2, for example, in the case where adjacent macroblocks include objects different from each other (cloud and sky), the difference value of DC components exceeds a threshold value, and thus there is a possibility that even a properly decoded macroblock may be determined as a macroblock on which error has occurred. In this case, error concealment is performed even on the properly decoded macroblock. More specifically, as is apparent when compared with the decoded image 11 obtained through error concealment where an error is properly detected as shown in FIG. 1, error concealment is performed even on the properly decoded macroblocks of the decoded image 12 obtained through error concealment where an error is falsely detected as shown in FIG. 2.

Therefore, an object of the present invention is to provide a decoding apparatus capable of accurately performing error concealment by reducing false error detection and detecting an error efficiently, and a decoding method of the same.

### Means to Solve the Problems

In order to solve the above-described conventional problems, a decoding apparatus which decodes a coded image coded on a per-block basis includes: a decoding unit configured to decode the coded image; an error candidate determination unit configured to determine a candidate block on which an error has possibly occurred, by using a quantization parameter obtained for each block through the decoding performed by the decoding unit; and a correction unit configured to correct blocks including and following the candidate block determined by the error candidate determination unit.

With this, it is possible to reduce false error detection and detect an error efficiently, by determining a candidate block on which an error has possibly occurred using a quantization parameter (Qp) which is not affected by an image property. The decoding apparatus according to the present invention utilizes that the quantization parameter is determined based on an amount of coded data which is generated by a coding device and normally does not change rapidly. Further, the decoding apparatus according to the present invention is capable of accurately performing error concealment by targeting blocks for error concealment as the determined candidate block and subsequent blocks.

Further, the error candidate determination unit may include: a difference calculation unit configured to calculate a difference value between a quantization parameter of a current block to be decoded and a quantization parameter of a block adjacent to the current block; and a determination unit configured to: determine whether or not an absolute value of the difference value calculated by the difference calculation unit is larger than a predetermined threshold value; and determine the current block or a block located immediately before the current block as the candidate block, when determined that the absolute value of the difference value is larger than the threshold value.

With this, it is possible to detect a rapid change in a quantization parameter and determine, to be a candidate error block, the block on which a rapid change is detected, so that false error detection can be reduced and an error can be efficiently detected.

Further, the determination unit may further determine whether or not the absolute value of the difference value is first to exceed the threshold value; and determine the current block or a block located immediately before the current block as the candidate block when determined as the first to exceed the threshold value.

With this, it is possible to detect the first block on which the quantization parameter has changed and to perform accurate error concealment by performing error concealment starting from the block on which a rapid change has been detected first.

Further, the decoding unit may further output an error signal indicating that decoding is impossible, when decoding of the coded image is disabled, the error candidate determination unit may notify the correction unit of the candidate block that has been determined, when the error signal is inputted, and the correction unit may correct blocks including and following the candidate block notified by the error candidate determination unit.

With this, it is possible to perform error concealment when decoding is actually disabled, enabling prevention of unnecessary error concealment.

Further, the error candidate determination unit may further include a threshold value determination unit configured to determine the threshold value based on a trend of the quantization parameter, and the determination unit may determine whether or not the absolute value of the difference value calculated by the difference calculation unit is larger than the threshold value determined by the threshold value determination unit.

With this, it is possible to change a threshold value used for detecting a change in the quantization parameter according to the coded bitstream inputted, so that false error detection can be further reduced and an error can be detected more efficiently. Since a trend of changes in the quantization parameter reflects a characteristic of a coding device, error concealment can be performed accurately even on coded images coded by different types of coding devices.

Further, the threshold value determination unit may determine, as the threshold value, an average value of absolute values of the difference values between quantization parameters of: a top and subsequent several blocks of the coded image; or a top and subsequent several blocks of a slice contained in the coded image.

Further, the determination unit may: select one of the current block or the block located immediately before the current block, according to an instruction from outside; and determine the selected block as the candidate block when the absolute value of the difference value is determined to be larger than the threshold value.

With this, it is possible for a user and the like to select either one of blocks as a candidate block. Selecting the block located immediately before the current block as a candidate block prioritize correction of error without fail. On the other hand, selecting the current block as a candidate block prioritizes obtaining a corrected image that is closer to an original image.

Further, the decoding apparatus may further include a selection unit configured to select, from among images that have been decoded, an image having an average value of quantization parameters of which a difference between an average value of the quantization parameters of the blocks in the images and an average value of the quantization parameter of decoded blocks in a coded image that is currently being decoded is equal to or less than a predetermined threshold value, wherein the correction unit is configured to correct blocks including and following the candidate block by using the image selected by the selection unit.

With this, it is possible to prevent a rapid change in the value of the quantization parameter of an image after performing error concealment, so that images which give no unnatural impressions to viewers can be obtained.

Further, the selection unit may select an image having the average value of the quantization parameter of which the difference is smallest.

With this, it is possible to reduce a change in the value of the quantization parameter, so that images which give no unnatural impressions to viewers can be obtained.

Further, in the coded image, a difference value between the quantization parameter for each block and a reference quantization parameter may be coded for each block, and the error candidate determination unit may: obtain the difference value for each block through decoding by said coding unit; determine whether or not the absolute value of the obtained difference value is larger than a predetermined threshold value; and determine the current block or a block located immediately before the current block as the candidate block in the case where the absolute value of the difference value is determined to be larger than the threshold value.

This eliminates the need for calculating the difference value, and thus it is possible to reduce processes for determining a candidate macroblock.

Further, the correction unit may correct blocks from the candidate block through a block located at an end of a slice including plural blocks.

With this, it is possible to perform decoding on a per-slice basis with the H.264 standard and the like. Therefore, only by performing error concealment through the block at the end of the slice, decoding can be performed normally on the subsequent slices.

Further, the present invention can also be embodied as a reproduction apparatus. A reproduction apparatus according to the present invention is a reproduction apparatus which reproduces a decoded image obtained by decoding a coded image coded on a per-block basis, and includes: the decoding apparatus described above; and a display unit configured to display the corrected decoded image obtained through the correction performed by the correction unit.

It should be noted that the present invention can be realized, not only as the decoding apparatus, but also as a method including the processing units included in the decoding apparatus described above, as its steps. Further, the present invention may be realized as a program which causes a computer to execute these steps. Furthermore, the present invention may be realized as computer-readable recording medium having the program stored thereon such as a compact disc read only memory (CD-ROM), information, data and a signal which represent the program. Further, the program, the information, the data and the signal may be distributed via a communication network such as the Internet.

A part or all of the structural components constituent elements constituting the respective decoding apparatuses may be configured from a single System-LSI (Large-Scale Integration). The System-LSI is a super-multi-function LSI manufactured by integrating constituent units on one chip, and is specifically a computer system configured by including a microprocessor, a ROM, a RAM (random access memory), and so on.

### Effects of the Invention

According to the decoding apparatus of the present invention, it is possible to perform error concealment accurately by reducing false error detection and efficiently detecting error.

### BRIEF DESCRIPTION OF DRAWINGS

FIG. 1 is a diagram for explaining a conventional error concealment technique.

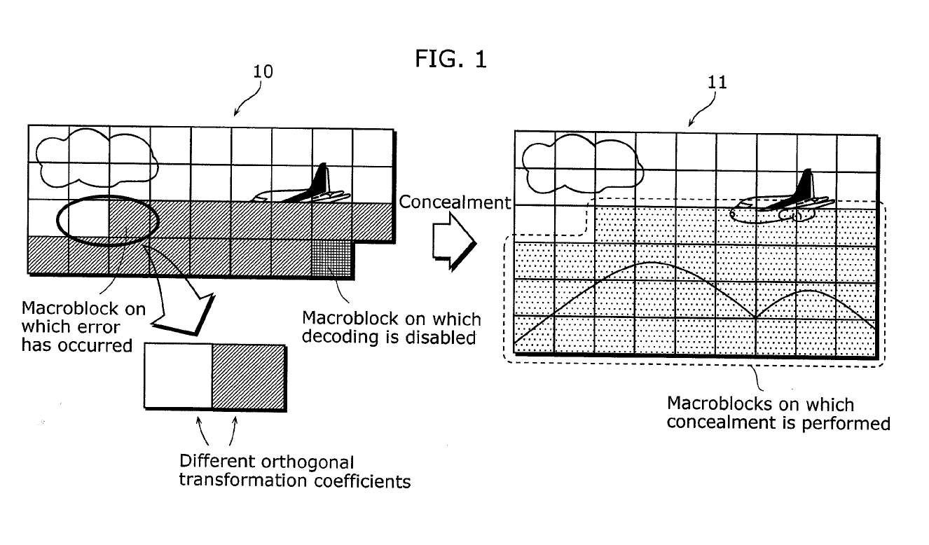

FIG. 2 is a diagram for explaining a problem in the conventional error concealment technique.

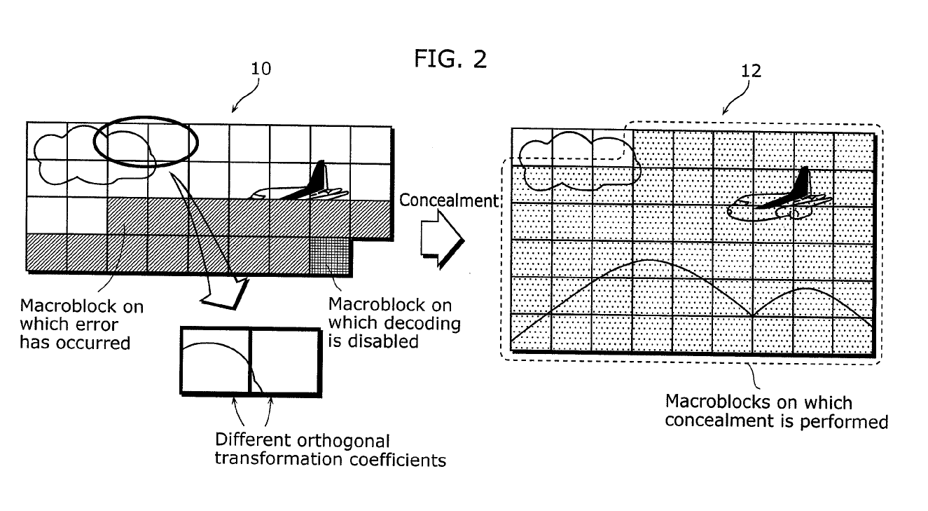

FIG. 3 is a block diagram which shows a configuration of a decoding apparatus according to a first embodiment.

FIG. 4 is a block diagram which shows a configuration of an error occurrence position determination unit of the decoding apparatus according to the first embodiment.

FIG. 5 is a flowchart which shows an operation of the error occurrence position determination unit according to the first embodiment.

FIG. 6 is a diagram which shows a structure of a coded bitstream of a slice corresponding to the H.264 standard.

FIG. 7 is a diagram which shows a configuration of an error occurrence position determination unit of the decoding apparatus according to a second embodiment.

FIG. 8 is a flowchart which shows an operation of the error occurrence position determination unit according to the second embodiment.

FIG. 9 is a block diagram which shows a configuration of the decoding apparatus according to a third embodiment.

FIG. 10 is a block diagram which shows a configuration of a reproduction apparatus including structural components of the decoding apparatus according to the present invention.

### NUMERICAL REFERENCES

10 coded image
11, 12 decoded image
100, 400 decoding apparatus
101, 401 variable length decoding unit
102, 402 inverse quantization unit
103 inverse transform unit
104 intra picture prediction unit
105 motion compensation unit
106 prediction image selection unit
107 image reconstruction unit
108 deblocking filter processing unit
109, 301 error occurrence position determination unit
110, 410 error correction unit
111, decoded image selection unit
112 frame buffer
201, 302 Qp difference calculation unit
202, 304 determination unit
203 output unit
303 threshold value determination unit
413 conceal image selection unit
500 reproduction apparatus
510 signal processing unit
520 LSI
530 memory
531 stream buffer
540 display unit

### BEST MODE FOR CARRYING OUT THE INVENTION

Embodiments according to the present invention will be described below with reference to the drawings.

### First Embodiment

A decoding apparatus according to the present embodiment is an apparatus that determines a macroblock on which an error has occurred, by using a quantization parameter and performs error concealment on a predetermined number of macroblocks including the determined macroblock and subsequent macroblocks in a decoding order, thereby decoding a coded image. Hereinafter, decoding processing will be described as being performed on a per-slice basis in the present embodiment. It is to be noted that a slice is composed of plural macroblocks and information regarding the slice is coded together with image information.

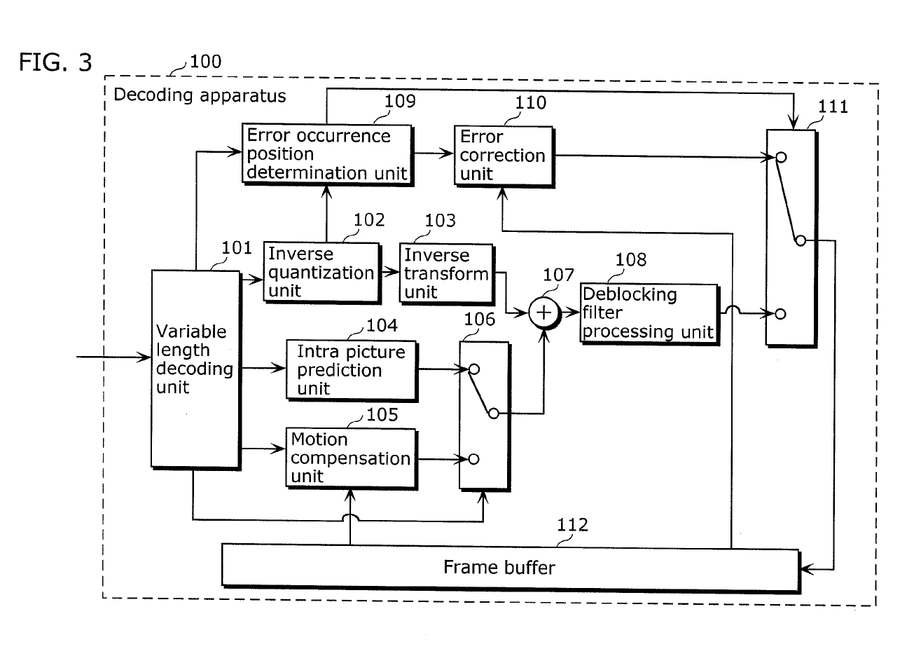

FIG. 3 is a block diagram which shows a configuration of a decoding apparatus according to the present embodiment. The decoding apparatus 100 in the diagram includes: a variable length decoding unit 101; an inverse quantization unit 102; an inverse transform unit 103; an intra picture prediction unit 104; a motion compensation unit 105; a prediction image selection unit 106; an image reconstruction unit 107; a deblocking filter processing unit 108; an error occurrence position determination unit 109; an error correction unit 110; a decoded image selection unit 111; and a frame buffer 112. Operations of each processing unit included in the decoding apparatus 100 will be described below in the order of processes for decoding a bitstream of a coded image which has been inputted.

The variable length decoding unit 101 decodes a bitstream of a coded image that has been inputted. Then, the variable length decoding unit 101 outputs obtained information, more specifically, outputs: quantization parameter information and a transform coefficient to the inverse quantization unit 102; intra picture prediction information such as a prediction mode to the intra picture prediction unit 104; motion information to the motion compensation unit 105; a coding type to the prediction image selection unit 106; a position of a current macroblock that is currently being decoded to the error occurrence position determination unit 109. Further, the variable length decoding unit 101, when detecting an error during decoding, notifies the error occurrence position determination unit 109 accordingly. For example, an error signal for inverting polarity is outputted to the error occurrence position determination unit 109 when an error is detected.

It is to be noted that a possible method for detecting an error includes: detecting an error when a value that does not exist in a variable length coding table referred to by the variable length decoding unit 101 is detected; or detecting an error when decoding processing is disabled due to detection of a start code at an unexpected position.

The inverse quantization unit 102 calculates a quantization parameter using the inputted quantization parameter information, and inversely quantizes the inputted transform coefficient using the quantization parameter that has been calculated. Then, the coefficient that has been inversely quantized is outputted to the inverse transform unit 103. Further, the quantization parameter used for inverse quantization is outputted to the error occurrence position determination unit 109. It is to be noted that the quantization parameter information includes, for example, a difference value from a criterial quantization parameter.

The inverse transform unit 103 inversely transforms, into a prediction error, the inversely quantized coefficient that has been inputted and outputs the prediction error to the image reconstruction unit 107.

The intra picture prediction unit 104 generates a prediction image using a pixel in a picture based on a prediction mode obtained from the intra picture prediction information that has been inputted, and outputs the generated prediction image to the prediction image selection unit 106.

The motion compensation unit 105 obtains a reference image from the frame buffer 112 using the inputted motion information, generates a prediction image using the reference image, and outputs the generated prediction image to the prediction image selection unit 106.

The prediction image selection unit 106 selects either the prediction image outputted by the intra picture prediction unit 104 or the prediction image outputted by the motion compensation unit 105 using the coding type that has been inputted, and outputs the selected image to the image reconstruction unit 107 as the prediction image.

The image reconstruction unit 107 adds the prediction error outputted by the inverse transform unit 103 to the prediction image selected by the prediction image selection unit 106, thereby reconstructing an image. Then, the image reconstruction unit 107 outputs the image that has been reconstructed to the deblocking filter processing unit 108.

The deblocking filter processing unit 108 outputs to the decoded image selection unit 111 a decoded image that is obtained by performing, on the reconstructed image, deblocking filter processing that smoothes an image.

The error occurrence position determination unit 109, in parallel with the above processing, determines a candidate error macroblock that is a macroblock on which an error has possibly occurred, by using the quantization parameter outputted from the inverse quantization unit 102. Determination of the candidate error macroblock will be described later in detail. Further, when notified of detecting an error by the variable length decoding unit 101, the error occurrence position determination unit 109 notifies the error correction unit 110 of the candidate error macroblock that has been determined. More specifically, the position of the determined candidate error macroblock is outputted, as an error occurrence position, to the error correction unit 110 and the decoded image selection unit 111.

The error correction unit 110 obtains, from the frame buffer 112, macroblocks to be referred to for motion compensation, which are located at the same position as the predetermined number of macroblocks located at and following the error occurrence position determined by the error occurrence position determination unit 109. The predetermined number of macroblocks located at and following the error occurrence position is replaced with the macroblocks that have been obtained, by performing motion compensation setting the value of motion vector as 0 and the prediction error as 0, so that error concealment is carried out. It is to be noted that, since decoding processing is carried out on a per-slice basis by the decoding apparatus according to the present embodiment, the predetermined number of macroblocks described above and later is the number of macroblocks from the candidate error macroblock that is the error occurrence position through the macroblock at the end of a slice.

The decoded image selection unit 111 selects a decoded image outputted by the deblocking filter processing unit 108, and stores the selected decoded image in the frame buffer 112. In the case where the error occurrence position is inputted by the error occurrence position determination unit 109, however, the decoded image selection unit 111 selects, for the predetermined number of macroblocks located at and following the error occurrence position, not the decoded image outputted by the deblocking filter processing unit 108 but the image outputted by the error correction unit 110 and stores the selected image into the frame buffer 112.

The frame buffer 112 stores the image selected by the decoded image selection unit 111.

Next, the error occurrence position determination unit 109 will be described.

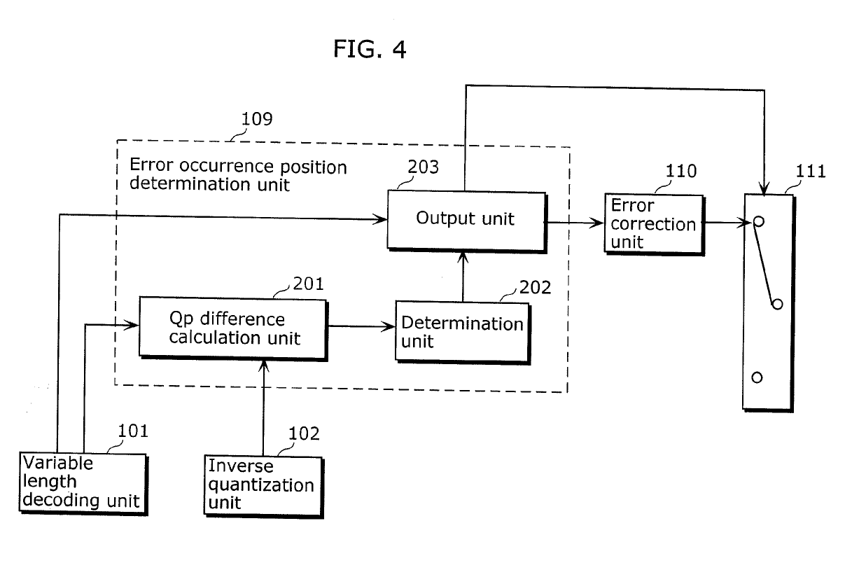

FIG. 4 is a block diagram which shows a configuration of the error occurrence position determination unit 109. The error occurrence position determination unit 109 includes: a Qp difference calculation unit 201; a determination unit 202; and an output unit 203.

The Qp difference calculation unit 201 calculates an absolute difference value between the quantization parameter of the current macroblock that is currently being decoded and the quantization parameter of a macroblock adjacent to the current macroblock. Then, the calculated absolute difference value is outputted to the determination unit 202. More specifically, whether or not to calculate the absolute difference value between the quantization parameters is determined by obtaining a position of the current macroblock from the variable length decoding unit 101 and determining whether or not the current macroblock is a macroblock located at the top of the slice. In the case where the current macroblock is the macroblock located at the top of the slice, the absolute difference value between the quantization parameters is not performed. The Qp difference calculation unit 201 obtains, for each macroblock, the quantization parameter necessary for calculating the absolute difference value between the quantization parameters from the inverse quantization unit 102.

The determination unit 202 obtains the absolute difference value calculated by the Qp difference calculation unit 201 and determines whether or not the absolute difference value is larger than a predetermined threshold value. In the case where the absolute difference value is determined to be larger than the threshold value, the macroblock located immediately before the current macroblock is determined as the candidate error macroblock. More specifically, whether or not the absolute difference value is the first to exceed the threshold value in the current slice that is currently being decoded is determined, and when determined as the first to exceed the threshold value, the macroblock located immediately before the current macroblock is determined as the candidate error macroblock. Then, the position of the macroblock determined as the candidate error macroblock is outputted to the output unit 203.

The output unit 203 temporarily stores the position of the candidate error macroblock inputted from the determination unit 202. Then, when the variable length decoding unit 101 detects an error and notifies the error occurrence position determination unit 109 that the error has occurred, the stored position of the candidate error macroblock is outputted, as the error occurrence position, to the error correction unit 110 and the decoded image selection unit 111. In the case where the output unit 203 does not store the position of the candidate error macroblock when the error occurrence position determination unit 109 is notified by the variable length decoding unit 101 that the error has occurred, the output unit 203 outputs, as the error occurrence position, the position of the macroblock on which the variable length decoding unit 101 has detected that the error has occurred.

According to the configuration described above, the decoding apparatus of the present embodiment determines the candidate error macroblock by using the quantization parameter. Further, it is possible to output an image without an error, by performing error concealment on a predetermined number of macroblocks from the candidate error macroblock onward.

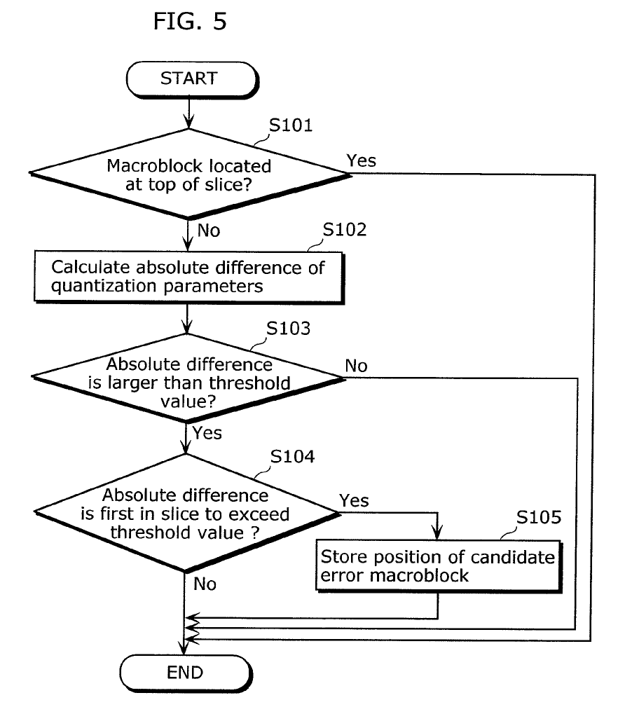

Next, processing of determining an error occurrence position performed by the error occurrence position determination unit 109 will be described FIG. 5 is a flowchart which shows an operation of the error occurrence position determination unit 109 according to the present embodiment. It is to be noted that the error occurrence position determination unit 109 performs, on a per-macroblock basis, determination of the error occurrence position; that is, the candidate error macroblock.

First, the Qp difference calculation unit 201 determines whether or not the current macroblock inputted from the variable length decoding unit 101 is the macroblock located at the top of the slice (S101). In the case where the current macroblock is the macroblock located at the top of the slice (Yes, in S101), the processing of determining an error occurrence position ends.

In the case where the current macroblock is not the macroblock located at the top of the slice (No, in S101), the Qp difference calculation unit 201 calculates an absolute difference value between the quantization parameter of the current macroblock and the quantization parameter of the macroblock located immediately before the current macroblock (S102). The absolute difference value that has been calculated is outputted to the determination unit 202.

Next, the determination unit 202 determines whether or not the inputted absolute difference value is larger than the predetermined threshold value (S103). In the case where the absolute difference value is smaller than the threshold value (No, in S103), the current macroblock and the macroblock located immediately before the current macroblock are determined not to be the candidate error macroblock, and the processing of determining an error occurrence position ends.

In the case where the absolute difference value is larger than the threshold value (Yes, in S103), the determination unit 202 determines whether or not the current macroblock determined to be larger than the threshold value is the first macroblock determined to be larger than the threshold value in the current slice that is currently being decoded (S104). In the case where the current macroblock is determined to be the macroblock that has appeared first in the current slice (Yes, in S104), the position of the macroblock located immediately before the current macroblock is stored in the output unit 203 as the candidate error macroblock (S105).

At this time, when a candidate error macroblock exists in the macroblocks previously decoded in the current slice, the existing candidate error macroblock is prioritized even when the absolute difference value is larger than the threshold value. In other words, the position of the candidate error macroblock stored in the output unit 203 is not updated to the macroblock located immediately before the current macroblock. More specifically, in the case where the current macroblock of which the absolute difference value is determined to be larger than the threshold value is determined not to be the macroblock that has appeared first in the current slice (No, in S104), the processing of determining an error occurrence position ends.

When the processing of determining an error occurrence position on the current macroblock ends, the processes described above (S101 to S105) are performed on the next macroblock as a new current macroblock.

The decoding apparatus according to the present embodiment repeatedly performs, on the macroblocks from the macroblock located at the top of the current slice through the macroblock located at the end of the current slice, the above-described processing of determining an error occurrence position as shown in FIG. 5. Then, when the processing on the current slice ends, the same processing is performed as targeting the next slice as a current slice.

Here, a structure of a coded bitstream and a quantization parameter of a slice which corresponds to the H.264 standard will be explained. Further, the reason for employing the quantization parameter for decoding apparatus according to the present embodiment and the advantages thereof will be described.

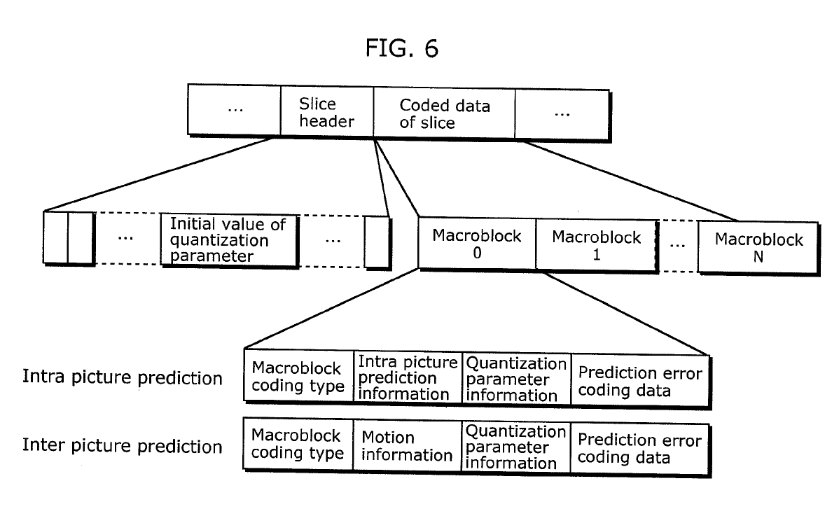

FIG. 6 is a diagram which shows a structure of a slice of a coded bitstream of corresponding to the H.264 standard. Coding processing is performed on a per-slice basis according to the H.264 standard. Therefore, a slice header which is a group of coded parameters of a slice is followed by coded data of the slice in a coded bitstream.

The coded data of the slice includes coded data of plural macroblocks. A structure of macroblock coded data differs depending on a coding type of the macroblocks (an inter picture prediction or an intra picture prediction).

A coding type of macroblocks is placed at the top of the macroblock coded data. Next, intra picture prediction information follows in the case where the coding type is the intra picture prediction, and motion information follows in the case where the coding type is the inter picture prediction. Further, quantization parameter information and prediction error coding data follow. It is to be noted that an order is not limited to this structure.

A quantization parameter is generated by using the quantization parameter information of the macroblock coded data, and each macroblock includes a quantization parameter independent of the coding type. For example, the quantization parameter information of the macroblock coded data is a difference value between quantization parameters of the macroblock and an immediately previous macroblock. A quantization parameter for each macroblock is calculated by combining the parameter of the immediately previous macroblock and the difference value. A quantization parameter of a macroblock at the top of the slice is calculated using information on a picture header and a slice header.

A value of a quantization parameter can be varied for each macroblock by varying a value of quantization parameter information of macroblock coded data in the process of coding. With a coding device for coding an image, an amount of coded data to be generated can be controlled for each macroblock by controlling a value of a quantization parameter.

However, when varying a value of the quantization parameter between adjacent macroblocks, a line appears at the boundary between the macroblocks, decreasing visual continuity in a decoded image and causing deterioration in an image quality. Therefore, it is usually avoided to vary a quantization parameter sharply between adjacent macroblocks when controlling a coding amount using the coding device. On the other hand, there is a characteristic that the rate of change in a quantization parameter is small between adjacent macroblocks. The present embodiment focuses on the fact that the rate of change in a quantization parameter is small, and in the case where the amount of change in a value of a quantization parameter obtained by performing variable length decoding is great between consecutive macroblocks, a position of a candidate error macroblock is determined by determining that an error has occurred in either one of the macroblocks.

The decoding apparatus 100 of the present embodiment determines a position at which an error has occurred by using a 10 quantization parameter. A coding parameter of a macroblock includes motion information, a type of the macroblock, and the like, which, in some cases, can be different in number per a single macroblock or has no value, depending on the coding type. Therefore, determining an error occurrence position by using the motion information, the type of the macroblock, and the like makes the configuration of the error occurrence position determination unit 109 complicated. On the other hand, the quantization parameter has only a single value for any macroblock regardless of coding types of the macroblock. Therefore, it is possible to make the configuration of the error occurrence position determination unit 109 of the decoding apparatus 100 simpler than the case of using other parameters such as motion information.

Further, the decoding apparatus 100 of the present embodiment determines an error occurrence position by using a quantization parameter determined based on the amount of coded data which is generated by the coding device. The quantization parameter is not affected by an image property, so that it is possible to perform detection regardless of the image property.

As described above, there are coding parameters other than the quantization parameter. However, in the case where such parameters as motion information and DC component of an orthogonal transformation coefficient are used, there has been a problem that an error may be falsely detected depending on an image property in a macroblock in which decoding is performed correctly. The decoding apparatus 100 of the present embodiment can: prevent false detection deriving from an image property; stably determine an accurate error occurrence position; and efficiently perform error concealment.

As described above, the decoding apparatus of the present embodiment determines a candidate error macroblock that is a position at which an error has occurred by using a quantization parameter that is not affected by an image property; and performs error concealment on the determined candidate error macroblock and the subsequent macroblocks. This reduces false detection of an error and enables an efficient error detection, so that error concealment can be performed accurately.

### Second Embodiment

The decoding apparatus of the present embodiment is a decoding apparatus that can vary a threshold value for each macroblock by determining, for each macroblocks, a threshold value used for a comparison with an absolute difference value in the decoding apparatus of the first embodiment.

In the decoding apparatus of the first embodiment, a predetermined fixed value is used as a threshold value used by the error occurrence position determination unit 109. When a coded bitstream to be decoded by the decoding apparatus is coded invariably by using the same method of controlling a quantization parameter, it is possible to determine an error occurrence position with high accuracy by constantly using a fixed threshold value. In the case of a decoding apparatus in which coded bitstreams generated by a variety of coding devices have been inputted, however, there is a demand that the method of controlling a quantization parameter correspond to each of the coding devices. The decoding apparatus of the present embodiment is a decoding apparatus for satisfying the above-described demand.

The configuration of the decoding apparatus of the present embodiment is that the error occurrence position determination unit 109 in the decoding apparatus 100 as shown in FIG. 3 is replaced with an error occurrence position determination unit 301. Other elements included in the decoding apparatus of the present embodiment is the same as those included in the decoding apparatus 100 excepting the error occurrence position determination unit 109 Hereinafter, descriptions shall focus on the differences by omitting descriptions for the same parts. The configuration of the error occurrence position detection unit 301 will be described in particular.

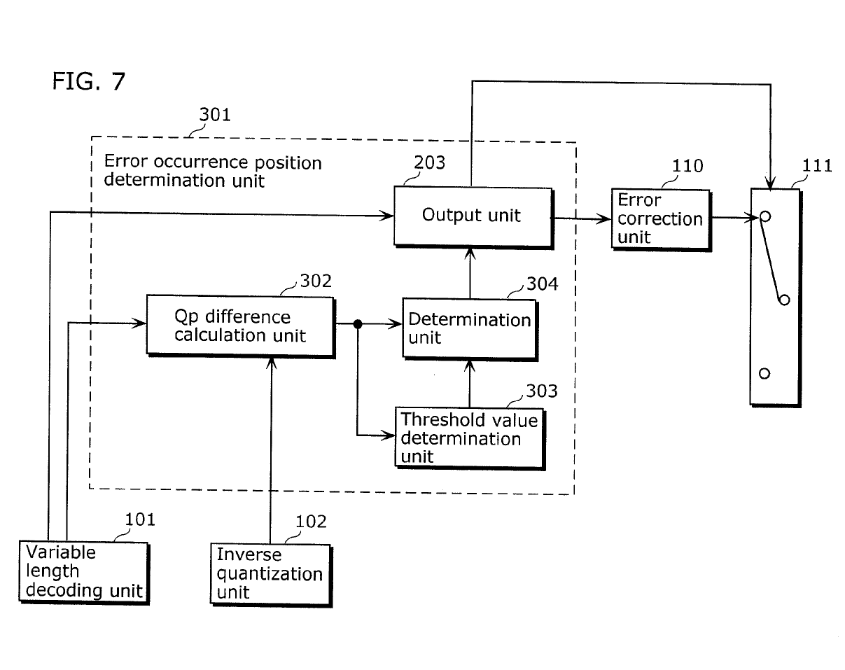

FIG. 7 is a block diagram which shows a configuration of the error occurrence position detection unit 301 of the present embodiment. The error occurrence position detection unit 301 determines a candidate error macroblock by using a quantization parameter in the same manner as the error occurrence position detection unit 109 of the first embodiment. It is to be noted that, whereas the threshold value used for a comparison with the absolute difference value has been set as the fixed value in the error occurrence position detection unit 109 of the first embodiment, the error occurrence position determination unit 301 sets a threshold value as a variable value. The error occurrence position detection unit 109 in FIG. 7 includes: a Qp difference calculation unit 302; a threshold value determination unit 303; a determination unit 304; and an output unit 203. It is to be noted that, in FIG. 7, the same numerals are assigned to the elements that perform the same operations as the elements of the first embodiment in FIG. 3 and the description that is overlapped will be omitted.

The Qp difference calculation unit 302 calculates an absolute difference value between the quantization parameter of the current macroblock and the quantization parameter of a macroblock adjacent the current macroblock. Then the calculated absolute difference value is outputted to the threshold value determination unit 303 and the determination unit 304. More specifically, whether or not to calculate the absolute difference value between the quantization parameters is determined by obtaining a position of the current macroblock from the variable length decoding unit 101 and determining whether or not the current macroblock is a macroblock located at the top of the slice. In the case where the current macroblock is the macroblock located at the top of the slice, the absolute difference value between the quantization parameters is not calculated. The Qp difference calculation unit 302 obtains the quantization parameter necessary for calculating the absolute difference value between the quantization parameters for each macroblock from the inverse quantization unit 102.

The threshold value determination unit 303 determines a threshold value to be used in the determination unit 304 based on a trend of the quantization parameter. More specifically, the absolute difference value between the quantization parameter of the current macroblock and the quantization parameter of a macroblock located immediately before the current macroblock is obtained and a threshold value is determined based on the obtained absolute difference value. The threshold value which has been determined is outputted to the determination unit 304.

The threshold value is calculated by estimating a trend of quantization parameter values outputted by a coding device that has generated a coded bitstream that is currently being decoded, based on a distribution of absolute difference values between quantization parameters of several adjacent macroblocks which are preceding in a decoding order in the current slice. For example, the threshold value is calculated as a value of several times the largest value of difference values between quantization parameters for several macroblocks. Or, the threshold value is calculated as a value of several times a variance added to an average value of difference values of quantization parameters for several macroblocks. As described above, various methods can be cited as a method of calculating the threshold value.

The determination unit 304 obtains: the absolute difference value calculated by the Qp difference calculation unit 302; and the threshold value determined by the threshold value determination unit 303, and determines whether or not the absolute difference value is larger than the threshold value. In the case where the absolute difference value is determined to be larger than the threshold value, the macroblock located immediately before the current macroblock is determined as the candidate error macroblock. More specifically, whether or not the absolute difference value is the first to exceed the threshold value in the current slice, and when determined as the first to exceed the threshold value, the macroblock located immediately before the current macroblock is determined as the candidate error macroblock. Then, the position of the macroblock determined as the candidate error macroblock is outputted to the output unit 203.

Operations performed by the output unit 203 are the same as those performed by the output unit 203 of the first embodiment, and thus the description will not be repeated here.

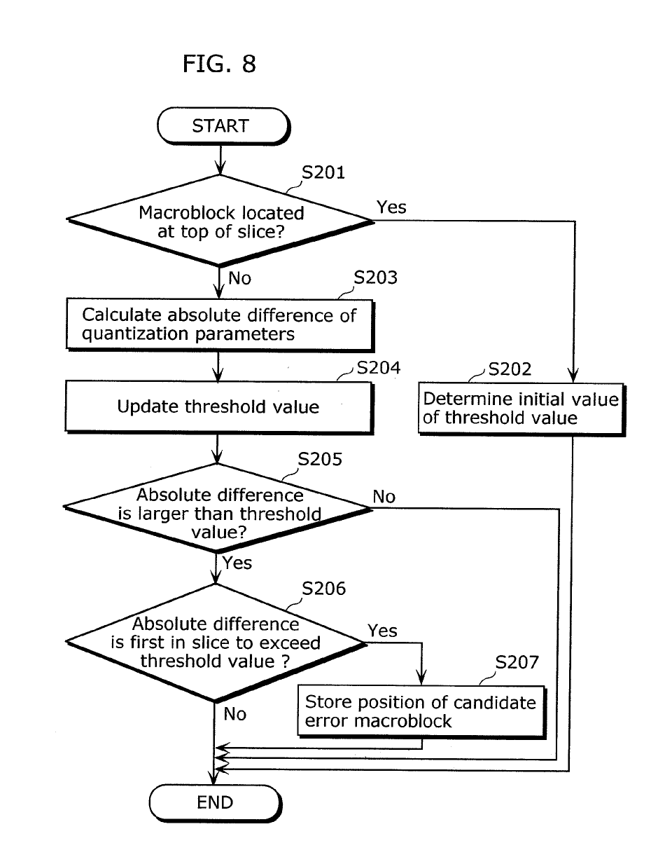

Next, processing of determining an error occurrence position performed by the error occurrence position determination unit 301 according to the present embodiment will de described. FIG. 8 is a flowchart which shows an operation of the error occurrence position determination unit 301 according to the present embodiment. It is to be noted that the error occurrence position determination unit 301 performs determination of the candidate error macroblock on a per-macroblock basis.

First, the Qp difference calculation unit 302 determines whether or not the current macroblock inputted from the variable length decoding unit 101 is the macroblock located at the top of the slice (S201). When the current macroblock is the macroblock located at the top of the slice (Yes, in S201), the threshold value determination unit 303 determines an initial value of the threshold value (S202), and the processing of determining an error occurrence position ends.

When the current macroblock is not the macroblock located at the top of the slice (No, in S201), the Qp difference calculation unit 302 calculates an absolute difference value between the quantization parameter of the current macroblock and the quantization parameter of the macroblock located immediately before the current macroblock (S203). The calculated absolute difference value is outputted to the threshold value determination unit 303 and the determination unit 304.

Next, the threshold value determination unit 303 determines the threshold value using the inputted absolute difference value and updates the threshold value (S204).

Then, the determination unit 304 determines whether or not the inputted absolute difference value is larger than the threshold value determined by the threshold value determination unit 303 (S205). In the case where the absolute difference value is smaller than the threshold value (No, in S205), the current macroblock and the macroblock located immediately before the current macroblock are determined as not the candidate error macroblock, and the processing of determining an error occurrence position ends.

In the case where the absolute difference value is larger 1o than the threshold value (Yes, in S205), the determination unit 304 determines whether or not the current macroblock that has been determined as having the absolute difference value larger than the threshold value is a macroblock that has appeared first in the current slice (S206). In the case where the current macroblock is determined to be the macroblock that has appeared first in the current slice (Yes, in S206), the position of the macroblock located immediately before the current macroblock is determined as the candidate error macroblock and the position thereof is stored in the output unit 203 (S207).

At this time, when a candidate error macroblock exists in the macroblocks previously decoded in the current slice, the existing candidate error macroblock is prioritized even when the absolute difference value is larger than the threshold value. In other words, the position of the candidate error macroblock stored in the output unit 203 is not updated to the position of the macroblock located immediately before the current macroblock. More specifically, in the case where the current macroblock of which the absolute difference value is determined to be larger than the threshold value is determined not to be the macroblock that has appeared first in the current slice (No, in S206), the processing of determining an error occurrence position ends.

When the processing of determining an error occurrence position on the current macroblock ends, the processes described above (S201 to S207) are performed on the next macroblock as a new current macroblock.

As described above, the quantization parameter is controlled by the coding device in order to control the coding amount when coding an image. Therefore, it is possible to utilize a characteristic of the coding device by calculating the threshold value reflecting a trend of changes in the quantization parameters of the coded bitstream inputted into the decoding apparatus.

As described above, the decoding apparatus of the present embodiment calculates a threshold value reflecting a trend of changes in the quantization parameters related to a characteristic of the coding device and uses the calculated threshold value for determining an error occurrence position, thereby making it possible to improve accuracy in detecting an error occurrence position. Therefore, when an error is detected by the variable length decoding unit 101, it is possible to determine an error occurrence position accurately and perform error concealment efficiently.

In other words, according to the present embodiment, it is possible to reflect a characteristic of the coding device that generated the coded bitstream currently being decoded, by determining the threshold value using the quantization parameter of the macroblocks that has been decoded, thereby making it possible to determine the error occurrence position more accurately.

It is to be noted that it has been described that the threshold value is calculated by the threshold value determination unit 303 based on the absolute difference values between quantization parameters of several adjacent macroblocks which are preceding in a decoding order in the current slice, however, the threshold value may be calculated by using an absolute difference value between quantization parameters of adjacent several macroblocks located at the top of the current slice, and the same threshold value may be used during decoding in the same current slice.

This eliminates the need for updating the threshold value in the macroblock located at the top of the slice and the subsequent macroblocks, thereby allowing reduction in throughput.

Further, it has been described in the present embodiment that the threshold value is determined for each macroblock, however, the threshold value may be determined for plural macroblocks.

### Third Embodiment

The decoding apparatus according to the present embodiment is a decoding apparatus that performs error concealment using a more suitable image by selecting an image to be used for error concealment processing based on a quantization parameter

In the decoding apparatus of the first embodiment, the error correction unit 110 performs error concealment by replacing the lo image placed at the same position as the current macroblock, among the reference image used for motion compensation or the image closest to the current image in order of display time, with a decoded image of macroblocks including the macroblocks located at the error occurrence position determined by the error occurrence position determination unit 109 and the subsequent macroblocks up to the macroblock at the end of the slice.

In the case where the coding device that has generated a coded bitstream to be decoded by the decoding apparatus does not vary too much a quantization parameter of the image placed close in order of display time, highly effective error concealment can be performed by using the reference image of motion compensation or the image placed closest in order of display time. This is made possible due to the fact that the reference image for motion compensation and the image placed closest in order of display time have only a small difference from the image that is currently being decoded.

However, in the case of the decoding apparatus which receives an input of a coded bitstream generated by the coding device that uses quantization parameters different between an image on which intra picture prediction is performed and an image on which motion compensation is performed, there is a demand that error concealment is performed by using an image having a value that is close to the quantization parameter of the image that is currently being decoded. This is because of the fact that, a picture that includes macroblocks of which quantization parameters significantly differ from each other gives visual uncomfortablility to a great extent. The decoding apparatus of the present embodiment is a decoding apparatus for satisfying the above-described demand.

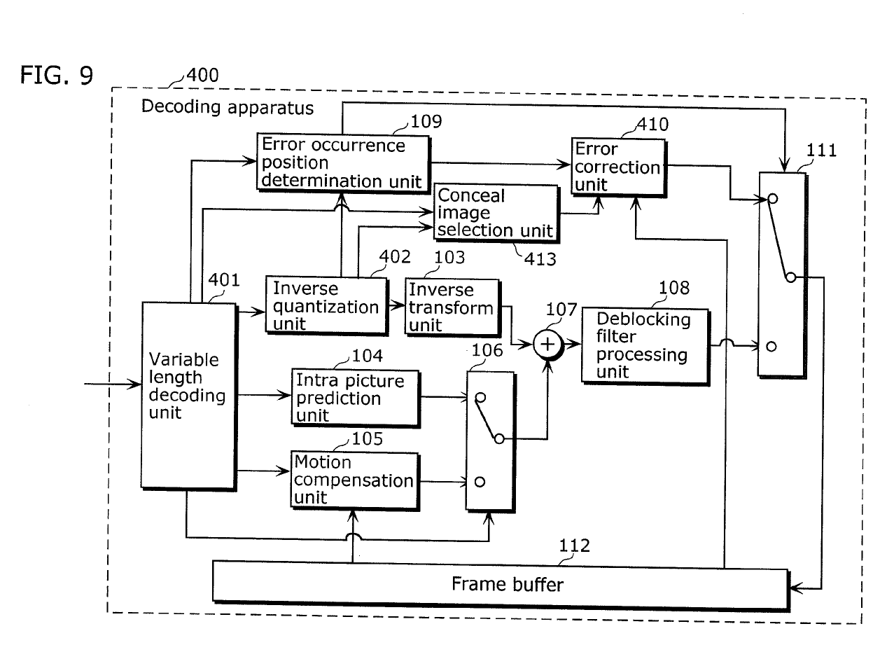

FIG. 9 is a block diagram which shows a configuration of a decoding apparatus according to the present embodiment. A decoding apparatus 400 of the diagram is different from the decoding apparatus 100 of FIG. 3 in that the variable length decoding unit 101, the inverse quantization unit 102, and the error correction unit 110 are replaced with a variable length decoding unit 401, an inverse quantization unit 402, and an error correction unit 410, respectively, and further, a conceal image section unit 413 is included. It is to be noted that the same numerals are assigned to the elements that perform the same operations as the elements of the first embodiment in FIG. 3 and the description that is overlapped will be omitted.

The variable length decoding unit 401 decodes a bitstream of a coded image inputted. Then, the variable length decoding unit 401 outputs: obtained quantization parameter information and a transform coefficient to the inverse quantization unit 402; intra picture prediction information such as a prediction mode to the intra picture prediction unit 104; motion information to the motion compensation unit 105; a coding mode to the prediction image selection unit 106; a position of current macroblock that is currently decoded to the error occurrence position detection unit 109; a picture number of an image used for a reference image of motion compensation by a current picture that is currently decoded and a picture number of an image placed closest in order of display time to the conceal image selection unit 413. Further, the variable length decoding unit 401, when detecting an error during decoding, notifies the error occurrence position detection unit 109 accordingly. It is to be noted that a method of detecting an error may include the same method as shown in the first embodiment.

The inverse quantization unit 402 calculates a quantization parameter using the inputted quantization parameter information, and inversely quantizes the inputted transform coefficient using the quantization parameter that has been calculated. Then, the coefficient that has been inversely quantized is outputted to the inverse transform unit 103. Further, the quantization parameter used for the inverse quantization is outputted to the error occurrence position detection unit 109 and the conceal image selection unit 413.

The conceal image selection unit 413 calculates an average value of the quantization parameters of all macroblocks that have been decoded, among macroblocks of the picture that are currently being decoded, by using the inputted quantization parameter, and selects the picture that has the closest average value from among average values of quantization parameters of all macroblocks of past pictures stored. Then, the picture number of the selected picture is transmitted to the error correction unit 410.

It is to be noted that the past pictures of which the average values of quantization parameters are to be stored may include pictures similar to the current picture, such as pictures temporally or spatially close, or more specifically, a reference picture of motion compensation, a picture immediately close in order of display time, and the like.

The error correction unit 410 obtains, from the frame buffer 112, macroblocks which are located at the same position as the predetermined number of macroblocks located at and following the error occurrence position determined by the error occurrence position determination unit 109 and which are indicated by the picture number selected by the conceal image selection unit 413. Then error concealment is performed by replacing the predetermined number of macroblocks located at and following the error occurrence position for the obtained macroblocks. It is to be noted that, according to the decoding apparatus of the present embodiment, the predetermined number of macroblocks described above is the number of macroblocks from the candidate error macroblock that is the error occurrence position through the macroblock at the end of a slice, as in the first embodiment.

As described above, the decoding apparatus of the present embodiment: stores the average value of quantization parameters of past pictures; selects the past picture which has the average value closest to the average value of quantization parameters of the macroblocks that have been decoded in the currently decoded picture; and performs error concealment by using the selected picture. With this, it is possible to reduce the difference of values of quantization parameters between macroblocks in the picture on which error concealment is performed, so that images which give no unnatural impressions to viewers can be obtained.

It is to be noted that the error occurrence position determination unit 109 of the present embodiment uses a fixed threshold value as in the first embodiment, however, the error occurrence position determination unit 301 described in the second embodiment may be used to change the threshold value.

Further, the conceal image selection unit 413 may select, not the picture that has the closest average value, but the picture, by calculating a difference between quantization parameter of the current picture, which has the difference value equal to or smaller than a predetermined threshold value.

The decoding apparatus and the decoding method according to the present invention have been described based on the embodiments, however, the present invention is not limited to the embodiments. Other forms in which various modifications apparent to those skilled in the art are applied to the embodiment, or forms structured by combining elements of different embodiments are included within the scope of the present invention, unless such changes and modifications depart from the scope of the present invention

For example, it has been described that the determination unit 202 and 304 determine an error occurrence position, in the current slice that is currently being decoded, as the position of a macroblock immediately before the current macroblock that is currently being decoded when the absolute difference value between the quantization parameters exceeds a predetermined threshold value for the first time. Contrary to the above, the current macroblock that is currently being decoded may be determined as an error occurrence position. Further, a macroblock located before the current macroblock by a predetermined number may be determined as an error occurrence position.

Further, which macroblock to be selected at this time may be determined according to a setting from outside, such as a setting by a user. With this, it is possible to prioritize correction of error without fail, by selecting a macroblock located immediately before the current macroblock as the candidate error macroblock. On the other hand, it is possible to prioritize obtaining an image after correction as an image closer to an original image, by selecting the current macroblock as a candidate macroblock.

Further, it has been described that the error correction unit 110 performs error concealment by performing motion compensation on macroblocks from the error occurrence position through the end of slice, with the value of motion vector set as 0. Contrary to the above, error concealment may be performed by replacing a current macroblock for an image which is the reference image closest in order of display time, and which is located at the same position as the current macroblock. With this, it is possible to perform error concealment on a moving picture with a large amount of motion by using an image closer to the current macroblock for decoding, so that a moving picture which gives no unnatural impressions to viewers can be outputted.

Further, it has been described that the Qp difference calculation units 201 and 302 do not calculate the absolute difference value between the quantization parameters for a macroblock located at the top of the slice. Contrary to the above, the absolute difference value between the quantization parameters may be calculated even for the macroblock located at the top of the slice. In this case, an absolute difference value between the quantization parameter of the macroblock located at the top of the slice and a fixed initial value is calculated. Or, the initial value may be determined using information included in the slice header, and an absolute difference value from the determined initial value may be calculated.

Further, it has been described that the determination units 202 and 304 determine, for each macroblock, whether or not the absolute difference value between quantization parameters that have been inputted is larger than the threshold value, and further, when determined that the current macroblock of which the absolute difference value is determined larger than the threshold value is the macroblock that has appeared first in the current slice, determine the macroblock located immediately before the current macroblock as the candidate error macroblock. Contrary to the above, it may be possible that the aforementioned determination processing is not performed in the case where the macroblocks that have been decoded lo in the current slice include a macroblock of which the absolute difference value between the quantization parameters is larger than the threshold value. The above configuration produces an effect that a processing load for error candidate determination can be reduced in a slice that includes a candidate error macroblock.

Further, the predetermined number of macroblocks on which error concealment is to be performed does not have to be the macroblocks from the candidate error macroblock through the macroblock at the end of a slice. For example, it does not have to be the macroblock at the end of a slice, but it may be the macroblock immediately before the macroblock on which decoding processing can be resumed.

Further, although the decoding processing is performed on a per-slice basis in each embodiment, the decoding processing may be performed on a per-coded image basis. In this case, the predetermined number of macroblocks on which error concealment is performed is, for example, the number of macroblocks from the candidate error macroblock through the macroblock at the end of the coded image.

Further, it has been described in each embodiment that the absolute difference value between the quantization parameters of adjacent macroblocks is calculated, and the calculated absolute difference value is compared with the threshold value to determine the candidate error macroblock. Contrary to the above, the candidate error macroblock may be determined by calculating, not the absolute difference value, but a trend, that is, a tendency of changes of quantization parameters between adjacent macroblocks. For example, the ratio of the quantization parameters between adjacent macroblocks may be calculated.

Further, it has been described that the error occurrence position determination units 109 and 301 obtain the quantization parameter calculated for each macroblock by the inverse quantization unit 102, and calculate the absolute difference value by using the obtained quantization parameter. Contrary to the above, it may be possible according to the H.264 standard, as shown in FIG. 6, to utilize the fact that the difference value of quantization parameters is coded for each macroblock in advance as quantization parameter information. More specifically, the error occurrence position determination units 109 and 301 may obtain the difference value of the quantization parameter decoded by the variable length decoding unit 101, and compare the obtained difference value of the quantization parameter with the threshold value. With this, it is possible to omit the Qp difference calculation units 201 and 302, thereby reducing a processing load of the error candidate determination.

Further, it has been described in each embodiment that the error concealment is performed in a decoding order, however, the error concealment may be performed in a transmitting order or receiving order.

Further, it has been described in each embodiment that each component operates based on a value inputted, however, each component may include a control unit that controls each processing unit and a function may be implemented by controlling each component with the controlling unit.

Further, the present invention may be implemented as a reproduction apparatus that includes the decoding apparatus described above and reproduces an image on which error concealment has been performed.

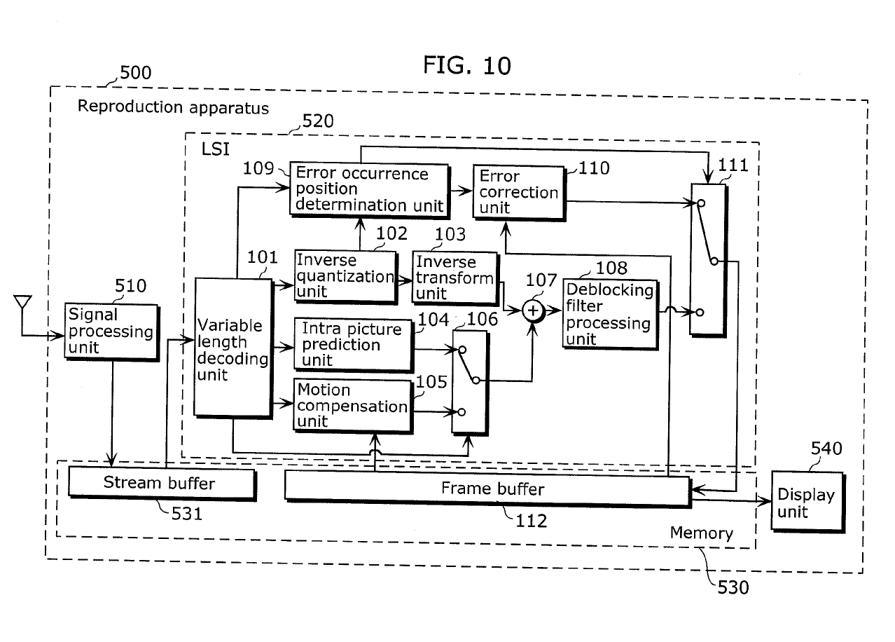

FIG. 10 is a block diagram which shows a configuration of a reproduction apparatus according to an embodiment of the present invention. A reproduction apparatus 500 in this diagram includes: a signal processing unit 510; an LSI 520; a memory 530; and a display unit 540.

The signal processing unit 510 stores a coded bitstream and the like, which has been obtained by processing a signal received via an antenna and the like, into a stream buffer 531 of the memory 530.

The LSI 520 is an integrated circuit that performs the processing of the decoding apparatus described above.

The memory 530 includes: the aforementioned frame buffer 112 and the stream buffer 531 that holds the coded bitstream inputted by the signal processing unit 510.

The display unit 540 displays a decoded image which is held by the frame buffer 112 and includes an image on which error concealment is performed by the LSI 520.

According to the configuration described above, the reproduction apparatus 500 can determine a candidate error macroblock on which an error has occurred and perform error concealment accurately on macroblocks including and following the candidate error macroblock. This makes it possible to reproduce an appropriate image which give no unnatural impressions to viewers.

Further, the present invention has been described using the H.264 standard as a coding method, however, the present invention may also be applied to the MPEG 2 standard, the SMPTE 421M-2006 Television. VC-1 Compressed Video Bitstream Format and Decoding Process (VC-1 standard), and so on.

Further, in each embodiment of the present invention, each functional block included in the decoding apparatus is typically implemented as a program that operates on an information device requiring a central processing unit (CPU) and a memory, however, a part or all of the functions may be implemented as an LSI which is an integrated circuit. In the LSI, these blocks can be integrated separately, or a part or all of them can be integrated into a single chip. The LSI here can be referred to as an IC, a system LSI, a super LSI, or an ultra LSI, depending on the degree of integration.

An integrated circuit used for such an embodiment is not limited to an LSI, and it may be embodied as a dedicated circuit or a general-purpose processor. It is also possible to use a field programmable gate array (FPGA) which can be programmed in the field after manufacturing an LSI, or a reconfigurable processor in which connection and setting of circuit cells inside an LSI can be reconfigured.

Furthermore, when a technology for the integrated circuit replacing LSI is developed with the advance of semiconductor technology or relevant technology, functional blocks can be integrated using the technology. Possible field of technology to be applicable includes, for example, bio technology and organic chemistry technology and others. Possible field of technology to be applicable includes, for example, bio technology and others.

### INDUSTRIAL APPLICABILITY

As described above, the present invention can be applied to a decoding apparatus and a decoding method, and useful for, for example, a broadcast reception apparatus capable of reducing quality deterioration in a decoded image when an error has occurred in a coded bitstream inputted.

1. A decoding apparatus which decodes a coded image coded on a per-block basis, said apparatus comprising:
a decoding unit configured to decode the coded image;
an error candidate determination unit configured to determine a candidate block on which an error has possibly occurred, by using a quantization parameter obtained for each block through the decoding performed by said decoding unit; and
a correction unit configured to correct blocks including and following the candidate block determined by said error candidate determination unit.

2. The decoding apparatus according to claim 1,
wherein said error candidate determination unit includes:
a difference calculation unit configured to calculate a difference value between a quantization parameter of a current block to be decoded and a quantization parameter of a block adjacent to the current block; and
a determination unit configured to: determine whether or not an absolute value of the difference value calculated by said difference calculation unit is larger than a predetermined threshold value; and determine the current block or a block located immediately before the current block as the candidate block, when determined that the absolute value of the difference value is larger than the threshold value.

3. The decoding apparatus according to claim 2,
wherein said determination unit is further configured to: determine whether or not the absolute value of the difference value is first to exceed the threshold value; and determine the current block or a block located immediately before the current block as the candidate block when determined as the first to exceed the threshold value.

4. The decoding apparatus according to claim 2,
wherein said decoding unit is further configured to output an error signal indicating that decoding is impossible, when decoding of the coded image is disabled,
said error candidate determination unit is configured to notify said correction unit of the candidate block that has been determined, when the error signal is inputted, and
said correction unit is configured to correct blocks including and following the candidate block notified by said error candidate determination unit.

5. The decoding apparatus according to claim 2,
wherein said error candidate determination unit further includes a threshold value determination unit configured to determine the threshold value based on a trend of the quantization parameter, and
said determination unit is configured to determine whether or not the absolute value of the difference value calculated by said difference calculation unit is larger than the threshold value determined by said threshold value determination unit.

6. The decoding apparatus according to claim 5,
wherein said threshold value determination unit is configured to determine, as the threshold value, an average value of absolute values of the difference values between quantization parameters of: a top and subsequent several blocks of the coded image; or a top and subsequent several blocks of a slice contained in the coded image.

7. The decoding apparatus according to claim 2,
wherein said determination unit is configured to: select one of the current block or the block located immediately before the current block, according to an instruction from outside; and determine the selected block as the candidate block when the absolute value of the difference value is determined to be larger than the threshold value.

8. The decoding apparatus according to claim 1, further comprising a selection unit configured to select, from among images that have been decoded, an image having an average value of quantization parameters of which a difference between an average value of the quantization parameters of the blocks in the images and an average value of the quantization parameter of decoded blocks in a coded image that is currently being decoded is equal to or less than a predetermined threshold value,
wherein said correction unit is configured to correct blocks including and following the candidate block by using the image selected by said selection unit.

9. The decoding apparatus according to claim 8,
wherein said selection unit is configured to select an image having the average value of the quantization parameter of which the difference is smallest.

10. The decoding apparatus according to claim 1,
wherein in the coded image, a difference value between the quantization parameter for each block and a reference quantization parameter is coded for each block, and
said error candidate determination unit is configured to: obtain the difference value for each block through decoding by said coding unit; determine whether or not the absolute value of the obtained difference value is larger than a predetermined threshold value; and determine the current block or a block located immediately before the current block as the candidate block in the case where the absolute value of the difference value is determined to be larger than the threshold value.

11. The decoding apparatus according to claim 1,
wherein said correction unit is configured to correct blocks from the candidate block through a block located at an end of a slice including plural blocks.

12. A decoding method for decoding a coded image coded on a per-block basis, said method comprising:
decoding the coded image;
determining a candidate block on which an error has possibly occurred, by using a quantization parameter obtained for each block in said decoding; and
correcting blocks including and following the candidate block determined in said determining.

13. An integrated circuit which decodes a coded image coded on a per-block basis, said integrated circuit comprising:
a decoding unit configured to decode the coded image;
an error candidate determination unit configured to determine a candidate block on which an error has possibly occurred, by using a quantization parameter obtained for each block through the decoding performed by said decoding unit; and
a correction unit configured to correct blocks including and following the candidate block determined by said error candidate determination unit.

14. A reproduction apparatus which reproduces a decoded image obtained by decoding a coded image coded on a per-block basis, said reproduction apparatus comprising:
a decoding unit configured to decode the coded image;
an error candidate determination unit configured to determine a candidate block on which an error has possibly occurred, by using a quantization parameter obtained for each block through the decoding performed by said decoding unit;
a correction unit configured to correct blocks including and following the candidate block determined by said error candidate determination unit; and
a display unit configured to display the corrected decoded image obtained through the correction performed by said correction unit.
